(19) United States
(12) Patent Application Publication
(10) Pub. No.: US 2017/0036962 A1
(43) Pub. Date: Feb. 9, 2017

(54) Foaming agent and method for the foaming and stabilizing of a building material slurry for porous lightweight building materials

(71) Applicant: CellConTec GmbH, Wolfsburg (DE)

(72) Inventor: Guenzel Graf von der Schulenburg-Wolfsburg, Wolfsburg (DE)

(21) Appl. No.: 15/218,212

(22) Filed: Jul. 25, 2016

(30) Foreign Application Priority Data
Aug. 3, 2015 (DE) 10 2015 009 827.6

(51) Int. Cl. C04B 38/10; E04B 1/80; E04C 2/284; C04B 7/04

(52) U.S. Cl. CPC C04B 38/10; C04B 7/04; E04B 1/80; E04C 2/284

(57) ABSTRACT

A foaming agent is used for foaming a building material binder paste or a building material slurry for producing porous lightweight-construction and insulating materials. On curing of the foamed slurry, the foam bubbles generate pores in the building material. The foam obtained from the foaming agent is stabilized using a long-chain or medium-chain polycarboxylate ether (PCE). The foaming agent includes a foam-forming ionic surfactant component, at least one fatty alcohol and at least one PCE in an aqueous-organic solvent which is selected from the group of alkyl glycols, alkylene glycols up to C6 alkyl, diglycols and diglycol ethers, and also, optionally, up to a maximum of 20 wt %, based on the mixture, of further ingredients.

### FIELD OF THE INVENTION

The invention relates to the use of new stabilizers for foam stabilization in a foamed building material slurry composed of binder, added water, a foaming agent comprising ionic foaming surfactants, in aqueous solvent with a fatty alcohol support, and optionally with additives and aggregates for the production of (porous) lightweight building materials.

The invention further relates to associated foaming agents for the foaming of a binder paste or a building material slurry, and to methods for producing porous lightweight-construction and insulating materials which result therefrom after setting and curing of the foamed slurry.

The invention relates, furthermore, to porous lightweight construction products obtainable with the method.

The field of operation of the invention relates to hydraulically setting building materials with a strength provided by binders and boosted or adjusted as desired by additives and aggregates. From binder and water (mixing water or added water), a binder paste is produced. Constituents of the binder react with the water and, in so doing, they set. In some cases this produces the building material directly, as in the case of filling plaster and certain lime renders, for example. In this case the binder paste forms the building material slurry directly. In other cases an aggregate, usually gravel, sand, ash or slag, or additives in the form of construction-chemical admixtures, is added to the binder paste, in order to qualities. The water-containing binder paste with aggregate and additives is referred to below as building material slurry. The foamed but as yet not set slurry—a viscous slurry—is referred to as foamed slurry. It sets to form the completed (porous) lightweight building material.

The building materials for the purposes of this description may be gypsum, concrete, lime or mixed forms thereof. The binders encompass slaked lime, gypsum in the form of natural gypsum and FGD gypsum, and a wide variety of different types of cement, preferably Portland cement or high-alumina cements. The designation of the gypsum, lime and cement binders customarily also includes those binders which in minor amount include a different binder or other, additional mineral constituents in powder form, examples being inorganic oxides (Mg, Si, Fe).

### BACKGROUND

The rheology and the setting behavior of building material mixtures have admittedly been topics of diverse investigation, especially for concrete and gypsum, but are dependent on a very large number of factors, in view of the numerous possibilities of combination, and for that reason have not been conclusively considered. The number of the combinations with aggregates and additives hinders conclusive investigations. The parameters, moreover, are frequently dependent to a considerable extent on processing temperature and processing pressure. Building materials, moreover, are natural materials, subject to natural fluctuations, and for that reason variations in the results are possible even with identical mixtures.

Lighter building materials with better heat and cold insulation qualities have been known for a long time, in the form of lightweight or porous building materials, which are of relatively low density by virtue of air inclusions or of admixing of lightweight aggregates such as perlites, expanded clay, pumice or cellulose. Disadvantages in comparison to air inclusions are the frequently high price of the aggregates, their limited availability and their often adverse effect on the insulation or sound properties of the building material.

EP 0 568 752 A1 discloses a lightweight gypsum which is produced by adding a mineral, porous filling material and preferably a perlite to a gypsum construction material. The pores in the filling material result in a construction material whose density is adjustable and is lower than that of solid gypsum.

Industrially, gypsums are put to diverse uses, including as construction and modeling materials, as insulants, as impression compounds, and for medical uses. Gypsums frequently possess desirable processing qualities such as high shapability and modelability prior to setting, and good machinability and sandability after setting. For many purposes they afford the desired degree of strength, and are relatively inexpensive and readily available. Chemically they constitute calcium sulfates, which may occur naturally in a variety of modifications or else be produced synthetically. The dihydrate (CaSO₄.2H₂O) gives up water of crystallization on heating, and, as it does so, it transitions first into a hemihydrates and later into an anhydrite. The at least partly dehydrated forms of gypsum are able to take up water again and recrystallize in so doing. Gypsum which is not fully hydrated is therefore able to set with absorption of water.

Present requirements in construction call for construction materials of low weight (low transport costs, ease of working), good heat and cold insulation values (energy saving), and improved sound insulation (living comfort, health). The basis for these qualities are lightweight building materials from which these products can be produced. In order to reduce the weight of established building materials and so to acquire the requisite qualities, air pores can be supplied durably in the process of producing the building material slurry. Binders used are equipped with qualities or combinations of qualities in such a way as to allow the production of products which are not presently available on the market. Established products can be greatly improved or furnished with new properties by means of a stable pore structure. In addition to utilization in industrial manufacture, it is desirable to be able to produce and use the material on the building site. In that context the foamed slurry ought to be stable and processable, producible in the desired density, and conveyable and workable without loss of density.

DE 20 56 255 A1 discloses a foaming agent for gypsum and cement compositions that uses, as surfactants, alpha-olefin sulfonates and/or certain alkali metal, ammonium or ethanolamine salts of sulfuric esters of alkoxylated alcohols. Furthermore, additional stabilizers may be added, especially fatty alcohols, and glycols as agents providing low-temperature protection. This stabilization is sufficient in some cases for building material slurries, if they are exposed to low pressure or none, are employed only at low structural height, or if small temperature fluctuations at the construction point are anticipated. At elevated pressure, with more greatly dimensioned structural height or under strongly elevated temperatures at the construction point, however, there may be failure of the pore structure in the gypsum paste.

### SUMMARY

Foam formers or gypsum and concrete are to date not satisfactory for all applications, since the foamed building material slurry may collapse spontaneously, or the density established may not be maintained during pumping or transporting.

An object of the invention is to overcome the foam stability drawbacks of the prior art and to provide a foaming agent for producing open-pored or closed-pored lightweight building materials, or, generally, a pore-bearing lightweight-construction and insulating material, where the as yet uncured, foamed building material slurry remains stable under processing conditions.

The foaming agent should be interpreted in this case simultaneously as a pore former for the cured building material.

Furthermore, under mechanical stress, in other words during pumping, during lowering, or at structural heights above 10 cm, the foamed slurry ought to remain substantially stable in volume, without developing inhomogeneities. When being conveyed by means of suitable pumps (for example peristaltic pumps and screw pumps), the building material foam is to arrive at the construction point without substantial loss of density and is to remain stable until fully set, and is to not develop any instabilities or inhomogeneities.

The method for producing the lightweight gypsums and gypsum foams is to be capable of application to all pure gypsums, construction gypsums, FGD gypsums (alpha and beta hemihydrates) and gypsum mixtures. Additionally, further pulverulent mineral building materials are to be processable, i.e. foamable with the method, including building materials containing lime, limestone, cement and/or silica, and this is also to be the case in a mixture with gypsum and any further aggregates.

The invention provides a new foaming agent which is greatly stabilized relative to the agents known from the prior art. The service lives of binder paste foams and building material slurry foams obtained with the foaming agent or with the pore former are excellent even at relatively high temperatures, with time-delayed curing and under pressure. The foamed slurries are pumpable as such and their volume is retained, and so they are able to cure with customary treatment on site or in formwork production, to give porous lightweight-construction and insulating materials. This applies generally to hydraulically curing building materials. The new foaming agent can be employed in combination with a wide variety of different binders and binder mixtures, including gypsum, lime, cement.

Specifically the object is achieved by the new use of a long-chain or medium-chain polycarboxylate ether for foam stabilization of a foaming agent for building materials; by a foaming agent for the foaming of a building material binder paste or building material slurry for producing porous lightweight-construction and insulation materials; and by the methods realizable with the foaming agent, and porous lightweight construction products obtained therewith.

The invention is based on the finding that polycarboxylate ethers (PCE) endow excellent stabilization on foams from a foaming agent for the production of porous lightweight-construction and insulating materials—namely binder paste foams and foamed building material slurries. Stabilized in particular are foaming agents on the basis of ionic foaming surfactants.

Polycarboxylate ethers (PCE) are comb polymers, as reproduced by way of example, for a single polymer unit, by formula (I).

[—CH₂—C(CH₃)(COONa)—CH₂—C(CH3)(COOCH₂(EO)ₙ—) Formula (I)

They are known base materials for plasticizer formulations for concrete, and can be modified very diversely in structure, molecular weight, charge density, chain lengths of main chains and side chains, and so on, in order to optimize the effect in relation to the application. The PCE main chains carry negative charges which facilitate attachment to the aggregate particles, while the side chains project into the paste solution. For the invention, long-chain and medium-chain PCEs are used, these being understood to be those having at least ten carboxylate units per molecule.

Claimed in the context of this invention are all long-chain or medium-chain polycarboxylate ethers which are available and can be used for concrete plasticizers and which are all also suitable for the purposes of this invention. The PCE here is always present directly in the liquid or dried foaming agent, in other words in direct assignment to the surfactant to be stabilized, in other words being mixed with said surfactant or in the same solution (namely in the foaming agent), whereas the PCE in the case of the known use as plasticizer additive is added in amounts of upwards of 0.1%, based on the binder content, in other words in high weight fractions, to the binder or to the mixing water for the paste. In this known form of use, however, the PCE lacks foam-stabilizing activity.

The foaming agents stabilized by the use in accordance with the invention are the agents which have already been known for a long time as an alternative to porous fillers but which have been practicably useful only in individual cases, these being foaming agents based on ionic foaming surfactants in aqueous organic solvents, generally in water/alcohol mixtures, more particularly water/glycol mixtures. It is essential that strongly foam-forming surfactants are used. The foam generated with these surfactants is frequently reinforced additionally with supports, examples being fatty alcohols.

The amount of the polycarboxylate ether (PCE) in the foaming agent not yet combined with a building material component is preferably at least 0.1 wt % up to preferably not more than 12 wt %, but may also be above this range, since there is no overdosing in the foaming agent, although higher concentrations no longer achieve any improved stabilization. The commercially available polycarboxylate ethers are in aqueous solutions. The solids content in that case is customarily between 25 and 60 wt %. The weight percent figures for the foaming agent are based on the PCE solids fraction specified for the product by the manufacturer (i.e. substance content or solids content).

The ratio of aqueous PCE to surfactant is preferably between 1:40 and 1:1, preferably between 1:4 and 1:1.

For use for the stabilization of the foaming agent foam, the polycarboxylate ether is employed preferably in combination with at least one glycol and at least one fatty alcohol, which are described in more detail below. The fatty alcohol: PCE ratio here is preferably from 4:1 to 1:6, and the PCE:glycol ratio here is from 1:40 to 60:1.

The generic foaming agent belonging to the invention in this context consists of the following base constituents:
at least one ionic, foam-forming surfactant, preferably in a substance content of at least 2 wt % in the foaming agent mixture, optimally about 4 to 10 wt %, but optionally—dependent on application—in much higher proportion as well,
at least one solvent from the group of lower glycols, including alkyl glycols, alkylene glycols and di-, tri- and polyglycols, preferably having up to 12 carbon atoms per molecule, and more preferably selected from the group of alkyl glycols and alkylene glycols up to C6 alkyl, diglycols and diglycol ethers,
a polycarboxylate ether, including mixed polycarboxylate ethers, preferably having at least ten carboxylate units per molecule,
at least one fatty alcohol or fatty alcohol mixture,
water and optionally a certain fraction of other organic-chemical adjuvants and/or acid or base for pH adjustment.

The amount of aqueous-organic solvent, i.e. water/glycol mixture, should be set such that all of the constituents dissolve well. The ratios and weight figures are reference points for the skilled person. The dissolving power is dependent on factors including the temperature, and hence the later processing temperature may be one of the factors playing a part in the choice of the weight ratios; these circumstances are known to the skilled person, and the foaming agent compositions may be optimized in a customary way.

The adjuvants and additives, including acids and bases for pH adjustment (including inorganic acids and bases), are present in a fraction from 0 up to not more than 20 wt %. For some foaming agents they are not required. Preferably, therefore, their amount is as small as possible, i.e. preferably 0-10 wt %, more preferably 0-5 wt %, more preferably 0-3 wt % and very preferably 0-2 wt %.

Suitable surfactants are, in principle, strongly foaming, alkali-stable surfactants or even those giving an alkaline reaction. The primary consideration is a high foaming power. Anionic surfactants are preferred, and especially sulfonates, alkyl sulfonates, more particularly alkali metal alkyl sulfonates, aklylene sulfates or alkyl ether sulfonates. The alkyl chains or alkylene chains of the sulfonates and sulfates are preferably long-chain and more preferably unbranched. Chain lengths greater than or equal to C8 and preferably between C10 and C20 may be regarded as typical.

Preferred surfactants include, among others, linear alkylate sulfonates, alphaolefin sulfonates, betaolefin sulfonates, alkyl ether sulfates, ethoxylated alkylphenols. Presently preferred are alphaolefin sulfonates, e.g. sodium C14-C16 olefin-sulfonate, and, among the alkyl sulfates, SDS and SLS.

Other anionic surfactants which can be used are acylamino acids and their salts, including acylglutamates, such as sodium acylglutamate, for example, di-TEA palmitoylaspartate, sodium caprylic/capric glutamate or sodium cocoylglutamate, acylpeptides, including hydrolyzed proteins and protein fractions, sarcosinates, taurates, acyllactylates, alininates, arginates, valinates, prolinates, glycinates, aspartates, propionates, lactylates, amide carboxylates; phosphates/phosphonates are further contemplated. Other examples are sulfosuccinates, sodium cocomonoglyceride sulfate, sodium lauryl sulfoacetate or magnesium PEG-n-cocoamide sulfate, alkylaryl sulfonates and acyl-isethionates, ether carboxylic and ester carboxylic acids, preferably the fatty acids, and also other known foaming anionic surfactants, of the kind available commercially.

The ionic, foam-forming surfactant comprises or consists of at least one anionic surfactant. An individual surfactant or a mixture of two or more surfactants may be used. As long as the foam power is retained, at least one other surfactant, more particularly a nonionic surfactant, may be present in a mixture alongside at least one anionic surfactant, though this is not preferred.

The solvent from the group of the glycols is preferably selected from ethylene glycol, propylene glycol, hexylene glycol, butylene glycol, butyldiglycol, diethylene glycol, dipropylene glycol, diethylene glycol alkyl ethers with C1-C5 alkyl, dipropylene glycol alkyl ethers with C1-C5 alkyl, or mixtures thereof. The solvent brings all of the constituents of the foaming agent together into solution, and forms a mixed phase with the water present in the foaming agent. Surfactant, PCE and optionally further ingredients are present in an aqueous-glycolic solution. The glycol is present in the foaming agent preferably at about 10 to 30 wt %, preferably at about 15-25 wt %, more preferably at about 18-22 wt %.

Fundamentally the agent comprises a supporting fatty alcohol, as already known from the prior art according to DE 20 56 255 A1 and DE 38 07 250 A1. The dodecanol specified there can also be used in this invention. Very suitable in general are long-chain fatty alcohols having a chain length of C8-C24 and preferably C10 to C20. Fatty alcohols contain by definition linear or sparsely branched, saturated or mono- or polyunsaturated hydrocarbon chains. Commercially available fatty alcohols are frequently of natural origin and consist frequently of mixtures for which the average chain length is specified. The chain lengths specified above should be seen, in the case of mixtures, as representing average lengths. The fatty alcohol, referred to here as support agent, interacts with the surfactant, initially dissolving it and, within the building material slurry structure, ensuring stability of the individual pores or air bubbles, which, however, must be additionally stabilized for longer service lives. Presently this is done by the PCE.

The foaming agent always includes, even as a concentrate, a certain water fraction. The degree of dilution, however, is flexible. For example, it may be desirable to have the surfactant-containing agent present in a highly concentrated form, in order to reduce costs of transport and of packaging for transfer to the location of use. Alternatively, for particular purposes, it may be advantageous to have the water that is needed for mixing up the binder already present in a preparation comprising the surfactant-containing foaming agent according to this invention—in order, for example, to save the user from multiple metering when mixing and to enable immediate deployment at the site of use. The water content of the agent may also be utilized for the purpose of adjusting the pH. A wide variety of different degrees of dilution are possible for the surfactant-containing agent. The water content ought to account for at least 10 wt % of the foaming agent.

For certain preferred embodiments, the volume of the basic foaming agent or basic concentrate is diluted further with water, to up to 25 times its volume, before it is foamed.

The pH of the surfactant-containing agent, which is used either as such in the form of the stated mixture, and for that purpose is optionally foamed beforehand, or whose individual constituents of the total mixture are mixed in at an appropriate point in the associated production method, is preferably greater than or equal to pH6, the pH more preferably being alkaline, i.e.

greater than 7. For many applications the pH may be favorably set to levels of 6 to 13, preferably of 9 to 12. For this purpose it is possible for aqueous alkali (preferably alkali hydroxide solution, NaOH or KOH) to be added to the agent if necessary.

The foaming agent may also comprise further adjuvants, including additives, including pH regulators and supplementary solvents, which ought to be added, however, only in minor amount.

Possible additives are as follows: retardants, accelerators, dyes, plasticizers, water glass, silica, alkali metal salts, and other known additives of the concrete, lime and gypsum industry.

The examples of possible supplementary solvents include C1-C20 monools or esters. For example, butyl acetate or acetyl acetate, methanol or ethanol, may be present as additional solvent in relatively small amount.

It is preferred, however, for the foaming agent to consist substantially of the claimed constituents identified above.

As far as it is possible to ascertain, there is no particular mixing sequence important for the production of the foaming agent.

One particular aspect of the invention is that the foaming agent—more particularly its concentrate or a relatively undiluted embodiment—can be freeze-dried or evaporated under vacuum and so converted into a dry state. The freeze-dried or otherwise evaporated foaming agent has particularly good storage and transport qualities. It may also be admixed directly to the binder to produce a self-foaming binder mix, in which case the air pores develop in the mixer without further addition of foaming agents. The dried foaming agent can also be dissolved in water at any time and used further in the same way as the liquid foaming agent described comprehensively above. If drying is not carried out to completion, the result is a powder which can be kept in cans or tubes and can likewise be stored and transported outstandingly.

The invention further embraces various methods for producing porous or “pory” lightweight-construction and insulating materials which can be obtained by means of the foaming agent stabilized optimally with PCE in accordance with the invention.

In the case of a first method regime, fundamentally, from a binder paste whose constituents are binder, mixing water and foaming agent, along with optional additives or aggregates for the specific building material, a binder paste foam is generated and is processed further in a conventional way to give the pory building material. In the case of gypsum, to which aggregates are not added in every case, the binder paste foam may at the same time be the completed construction foam which is cured and dried—in that case, binder paste is the same as building material slurry.

In the case of a second method regime, fundamentally, from a building material slurry whose constituents are binder paste, aggregates, additives, optionally further water for addition, and foaming agent, and also, optionally, additives for the specific building material, a building material slurry foam is generated and is processed further in a conventional way to give the pory building material, a concrete, for example.

The foaming agent is foamed either in a first step with water or with the water already present in the foaming agent, to give a foaming agent foam. This is done, for example, in a foam generator. Apparatus for this purpose is known to the skilled person. The foam from the foaming agent can then be introduced into the building material processing operation as described in more detail below, in order to give the desired building material foams. Both liquid and dried foaming agent can be used in this way.

In preferred embodiments, the foaming agent is foamed, optionally with additional water, and the resulting foam is alternatively combined
1. with mixing water for a binder,
2. with a binder paste composed of binder and mixing water and also, optionally, additives, or
3. with a building material slurry composed of the binder paste and aggregates,
   to give the binder paste foam or the completed foamed building material slurry. The foam from the foaming agent here may be added within a binder paste preparation process advantageously to at least one of the starting materials in a container, or may be supplied to a transfer line, to a mixer or foam generator, to a pump or a fresh building material delivery line.

An alternative possibility, particularly for gypsum as binder, is to add a dried foaming agent to the gypsum-based solids mix and to process the gypsum in a customary manner. Foaming in this case takes place by intensive mixing of gypsum and mixing water.

Specifically the dry, pulverulent or pasty foaming agent is added to a dry binder or to the mixing water, and the binder paste foam is generated directly during mixing of the binder with the mixing water or water for addition, and is processed further in a customary way.

All method variants as elucidated in more detail below in connection with the figures, using gypsum as an example, are suitable in principle for use with different binders, generating variants of pory lightweight-construction and insulating materials and also associated products.

As already described above, the binder for the method of the invention consists preferably of cement, gypsum, lime, in each case alone or in any desired mixture with one another or with other mineral constituents.

The method of the invention includes the possibility for the binder paste foam or the foamed building material slurry, or generally the building material foam, to be transported directly to the construction point, preferably by pumping, and to be cured on site. If the binder in the foamed building material slurry is Portland cement or high-alumina cement, this material may be used in road building, to replace gravel and crushed-stone layers, frost protection layers, hydraulically set (bearing) layers, and also parts of the asphalt topping.

The foamed building material slurry may also be introduced into cavities to produce, with other building materials, an integrated material system. This is particularly advantageous for flooring insulation or architectural facing insulation systems, particularly if these systems are being implemented subsequently, as part of building renovation, therefore. The porous lightweight-construction and insulating material of the invention is highly suitable in particular, for insulating and leveling materials in floor, roof and wall, for screeds and underlying floor leveling compounds, for ceiling plasters and wall plasters.

The foamed building material slurry obtained according to the various method variants of the invention is stable under processing conditions, meaning that it can be transported in mobile mixers, forced through hoses and pipeline systems using suitable pumps, transferred into molds for formwork products, or introduced, as insulating material, into interspaces or onto floors, without any increase in its density in the process.

The method, however, also includes the possibility of pouring the building material foam into molds to produce moldings, especially construction elements.

In the manufacture of plasterboard panels, the foaming agent may reduce considerably the weight of the end product, by increased formation of stable air pores, and help to raise the flexural tensile strength of the boards. This may also be done in an integrated way with further aggregates.

In one particularly preferred embodiment, the forming and curing takes place under pressure and at elevated temperature in an autoclave, or in a mold which provides the conditions of an autoclave. This method is very advantageous, among other things, for the production of mechanically very stable lightweight porous gypsum moldings and products of autoclaved aerated concrete (YTONG).

In a further embodiment it is possible to use one of the above shaping methods to produce blocks, from which further products arise by further machining. Provision is made in particular for shaped or freely poured blocks obtained with the method of the invention from lightweight-construction and insulating materials to be cut, sawn or milled to form products such as lightweight construction boards, internal and external insulating elements, particularly architectural facade insulation and panels, or shaped blocks and shaped elements.

If this method is carried out with material of relatively high density, causing the required strengths to be established, the method can be used to produce masonry blocks of a wide variety of different classes.

As may be seen, the method allows access to a multiplicity of porous lightweight construction products, preferably made from lightweight gypsum or porous gypsum or from lightweight concrete or porous concrete.

Gypsum

Methods and foaming agents (pore formers) are applicable across all varieties of gypsum, i.e. dehydrate, hemihydrate and anhydrite in the various modifications, of natural or synthetic origin, including all FGD gypsums, particularly alpha- and beta-hemihydrates. All gypsums may comprise the gypsum aggregates customary for purposes of use; in other words, building gypsum may comprise, for example, (ground) gravel, sand, silica products, setting retardants and setting accelerators or the like. Provision is made, however, for the gypsum fraction, based on the dry mass, to be preferably at least 12.5 wt %, more preferably at least 80 wt % and very preferably 100 wt %. The method can likewise be employed very well with pure gypsum. The method is performed preferably with very largely aggregate-free gypsum, since the end product thereof yields the maximum possible compressive strength at low densities.

Agents and methods according to the invention lead to stable gypsum foams even with low foam density (<500 kg/m³). Lightweight gypsum products produced therefrom possess high heat insulation values. The gypsum foam here may be processed in a volume-retaining way, meaning that the foam does not exhibit excessive expansion on curing (no swelling), and nor does it display contraction after curing (no shrinkage cracks). Gypsum mixtures behave correspondingly. With other binders, the swelling and contraction behavior is fundamentally different, though adverse effects are at least alleviated by the pore structure.

The density of the foamed building material slurry and hence of the end products may be adjusted within wide limits. As a result, in accordance with the invention, the lightweight gypsum can be produced in virtually any desired density. Wet weights of between about 90 kg/m³ and 1700 kg/m³ have been produced and trialed.

The foamed building material slurries obtained with the agent of the invention can be processed even at temperatures up to 0° Celsius, and possess outstanding thermal insulation properties and, in spite of their low density, very good sound insulation properties.

For gypsum, particularly good and stable lightweight gypsum is formed at gypsum foam densities of 450 to 850 kg/m³.

### DESCRIPTION OF FIGURES

In the drawing:

FIG. 1 shows the diagrammatic process of production of lightweight building material on the building site or in industrial manufacture;

FIG. 2 shows the diagrammatic process of production of lightweight building material in a slightly altered method regime;

FIG. 3 shows the schematic process of production of lightweight building material using a dried foaming agent.

### DESCRIPTION

The invention is illustrated below using formula examples and method examples. These examples are intended to serve solely for more effective illustration of the invention, and not to restrict it in its general aspects.

### FORMULA EXAMPLES=FOAMING AGENT

### Example Foaming Agent 1

18.0 wt % anionic surfactant, sodium C14-16 olefinsulfonate

2.0 wt % fatty alcohol, C12-C14 mix 50:50

18.0 wt % butyldiglycol (diethylene glycol monobutyl ether)

6.0 wt % Melflux PCE 239 L/35% N.D. (BASF)

56.0 wt % water

100% total solution

### Example Foaming Agent 2

12 wt % anionic surfactant, sodium C14-16 olefinsulfonate

15.0 wt % sulfuric ester salt

2.0 wt % fatty alcohol, C10-C12 mix 25:75

18.0 wt % hexylene glycol

6 wt % MELFLUX PCE 1493 L/40% (BASF)

47.0 wt % water

100% total solution

### Example Foaming Agent 3 (Concentrate)

40.0 wt % anionic surfactant, sodium C14-16 olefinsulfonate

3.0 wt % fatty alcohol, C12-C14 mix 50:50

34.0 wt % butyldiglycol

8.0 wt % PCE, MELFLUX PCE 239 L/35% (BASF)

15.0 wt % water

100% total concentrate, dilutable with 2-22 1 of water per liter of concentrate

Foams from these foaming agents are mixed with various binder pastes or binder slurries to form foamed building material slurries.

A building material paste is produced conventionally.

The compositions identified in Examples 1 or 2, among others, may be selected, for example. The precise solids composition and the water content are guided by the end use of the foamed slurry being produced. Accordingly, the nature and amount of the selected aggregates and composition of the binder mix are selected. Depending on the desired density, various amounts of the foaming agent are used per kilo of slurry, according to the formula examples for the foaming agents.

### Example Mixture 1 Gypsum Paste

40 wt % (of the binder weight) mixing water, the desired amount of alpha hemihydrate, 2% of retardant

### Example Mixture 2 Cement Paste

50 wt % (of the binder) mixing water, the desired amount of CEM I 42.5 Portland cement, 2.0 wt % melamine sulfonate plasticizer

### Examples Applications

APPLICATION 1: Production of a gypsum board for interior insulation. Required wet density=450 kg/m³, binder used: gypsum, alpha-hemihydrate incl. retardant, aggregates: none.

To produce one cubic meter of foamed gypsum slurry, achieving the desired density after curing in the ambient air in the drying container, 450 kg of gypsum paste are needed. According to Example 1, 450 kg of gypsum paste contain 321 kg of gypsum and 129 liters of water. Gypsum has a density of 1.7. 321 kg of gypsum therefore have a volume of 189 liters. Together with the water, the resulting volume is 318 liters. The volume of 682 liters remaining as the balance to one cubic meter are made up with the foam from example foaming agent 1, and mixed with the paste to give one cubic meter of foamed gypsum slurry.

APPLICATION 1a: Production of a lightweight concrete panel for exterior insulation. Required wet density=350 kg/m³, binder paste used as per example mixture 2.

To produce one cubic meter of foamed slurry, achieving the desired density after curing in the ambient air in the drying container, 350 kg of cement paste are needed. According to example mixture 1, 350 kg of cement paste contain 233 kg of cement and 117 liters of water. Cement has a density of 3.1. 233 kg of cement therefore have a volume of 75 liters. Together with the water, the resulting volume is 192 liters. The volume of 808 liters remaining as the balance to one cubic meter are made up with foam from example foaming agent 1, and mixed with the paste to give one cubic meter of foamed slurry.

APPLICATION 2: Production of a leveling compound for liquid incorporation on the building site beneath the screed. Desired density=600 kg/m³, desired strength 1.5 N/mm², binder used: gypsum, natural anhydrite, aggregates: 20 wt % of gravel ground to low particle size, initiator potassium sulfate 2.0 wt % of the binder.

To produce a foamed gypsum slurry which cures in the ambient air at the construction point, 480 kg of anhydrite with a density of 2.2 and a volume of 218 l are required. The aggregates possess a density of 2.7 and hence a volume of 45 liters, and so 737 liters of foam are needed for one cubic meter of leveling compound. 2 liters of concentrate as per example foaming agent 3 are introduced into the mixing water, and the overall mixture is mixed in an intensive mixer to give the foamed slurry.

APPLICATION 3: Production of a bearing layer in road construction, which when used allows all of the layers and elements beneath the covering asphalt layer to be done away with.

Desired density. 850 kg/m³, desired compressive strength: 3.5 N/mm², binder used: Portland cement, CEM I 42.5 N.

To produce a foamed concrete slurry which cures at the construction point, 565 kg of cement with a density of 3.1 and a volume of 182 liters are required. Together with the volume of the mixing water, of 283 l, this makes a volume of 465 liters, which is mixed with the slurry together with 535 liters of foam, produced from example foaming agent 2, and gives the desired material.

APPLICATION 4: production of a lightweight gypsum plaster for the interior region of an outside wall, whose air pores equip the material with a heat insulation value. In calculating the U value of a wall construction, this value can be counted in and so help to reduce the overall wall construction. Additionally, the lightweight gypsum plaster is easier to process than the standard plaster, on account of its low weight, and the coverage of the raw material used is increased considerably.

Desired density=750 kg/m³, binder used: gypsum, alpha-hemihydrate, (customary DIY store or building material supplier) bagged product 25 kg, aggregates: none.

To produce a lightweight gypsum from foamed gypsum slurry, which attains the desired density after curing in the ambient air in the drying container, 25 kg of gypsum (bagged product) are mixed with 10 liters of water to form gypsum paste. Gypsum has a density of 1.7, giving a volume of 15 liters for 25 kg of gypsum. Together with the water, the resulting volume is 25 liters.

Alternative 1: The paste is mixed with 25.5 liters of foam as per example foaming agent 1 to form a foamed slurry, the foam being produced beforehand in a standard foam generator, FINKE for example, and then incorporated by mixing.

Alterative 2: The foaming agent concentrate in dried or pasty form is added to the solid or to the mixing water, and the mixture is foamed in an intensive mixer. This is done by adding 1.0 g of powder (produced from example pore former 3) to 25 kg of gypsum.

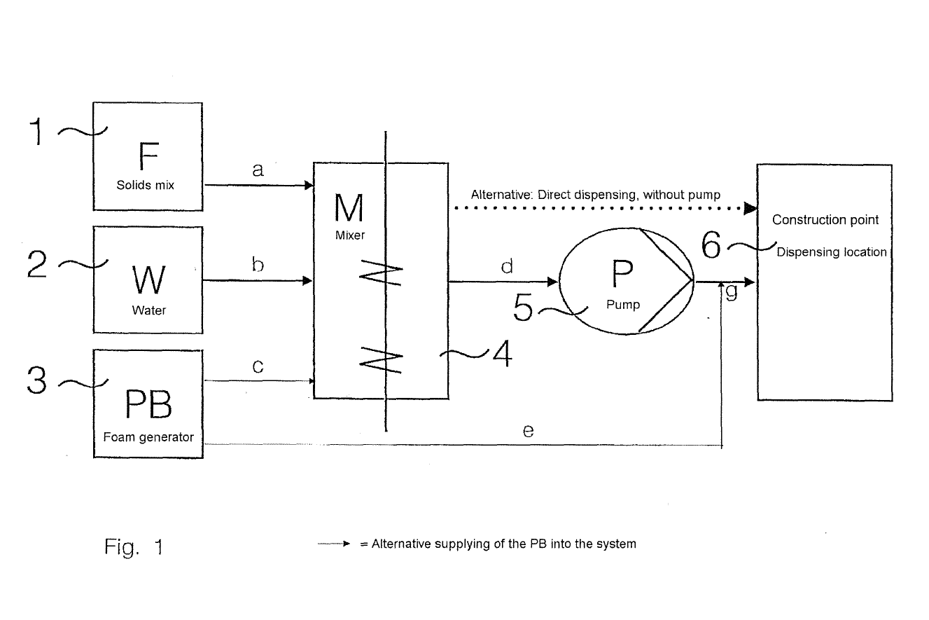

FIG. 1 shows a first procedure for the production of a foamed building material slurry, from which, after drying, lightweight building material products (e.g. lightweight gypsum products) come about or are produced. The starting materials needed are supplied from reservoir vessels 1, 2 and 3 to a standard mixer 4. A wide variety of different types of mixer can be used. However, the mixing intensity ought to be variably adjustable, so that the desired density (the desired pore volume) is achieved in the slurry, according to the foaming agent variant used and solids mix used.

The binder is charged dry to the container 1. It may contain aggregates. This solids mix is conveyed via a line “a” into the mixer 4. Alternatively, binder and aggregates can be held in two separate reservoir and delivery vessels, both of which would be connected via separate lines to the mixer (not shown here). In parallel with this, the mixing water from container 2 is conveyed via a line “b” into the mixer 4.

Foaming agent is charged to container 3 and conveyed via a line “c” into the mixer 4. Alternatively, the foaming agent (pore former, PB) can be produced with a foam generator and conveyed directly into mixer 4. In the mixer 4, a binder paste foam is generated, which is passed via a feed “d” into a pump 5, and passed further via a hose “g” to a construction point 6 on a building site, or into a mold. Alternatively, the foam produced using the foam generator can be passed directly by a line “e” into the binder paste or, where aggregates are present, into the building material slurry. For this purpose, the foam from line “e” is injected under pressure into the paste jet of the unfoamed binder paste or of the unfoamed building material slurry.

This admixing by injection into the paste jet is preferred in the case of continuous production operation. The foamed slurry can be used to fill molds in which the slurry sets, which is not implemented in detail in this diagrammatic representation.

The transfer line “g” may be a flexible hose, with which the foamed slurry is introduced at a construction site. Possible uses of the slurry are as insulating material in partition walls, as plaster, as floor leveling compound or as screed.

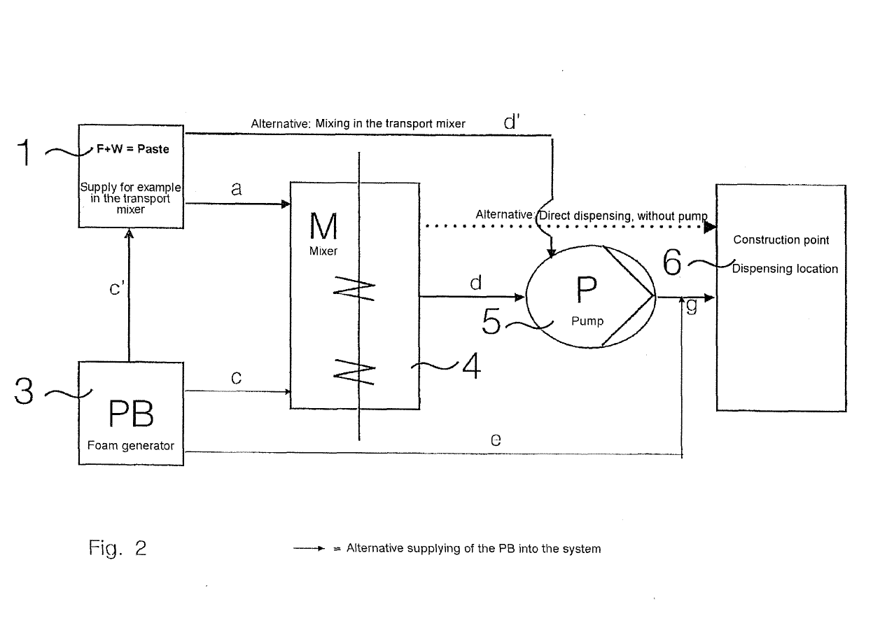

FIG. 2 shows a modified method. In this case, in container 1, a binder paste generated beforehand is charged directly, or the paste is supplied directly from the transport mixer via line d′ to the mixer 4, in which the foamed slurry is generated. Alternatively, the foam may be conveyed via line c′ to the transport mixer, with the transport mixer fulfilling the function of mixer 4 and replacing it. The two binder paste and foam components are mixed in the mixer 4 or in the transport mixer, and a binder paste foam is formed which remains stable under the mixing conditions, as in the method of FIG. 1. From the mixer 4 (via path d) or from the transport mixer (via path d′), the completed binder paste foam is brought by means of the pump 5 through hose g to the construction point 6 or into a mold. Aggregates may have been added beforehand, from a separate container, directly into the mixer 4 or the transport mixer. The foamed building material slurry is brought like a paste via the line d, pump 5 and line/hose g to the construction point 6, or discharged directly from the transport mixer at the construction point.

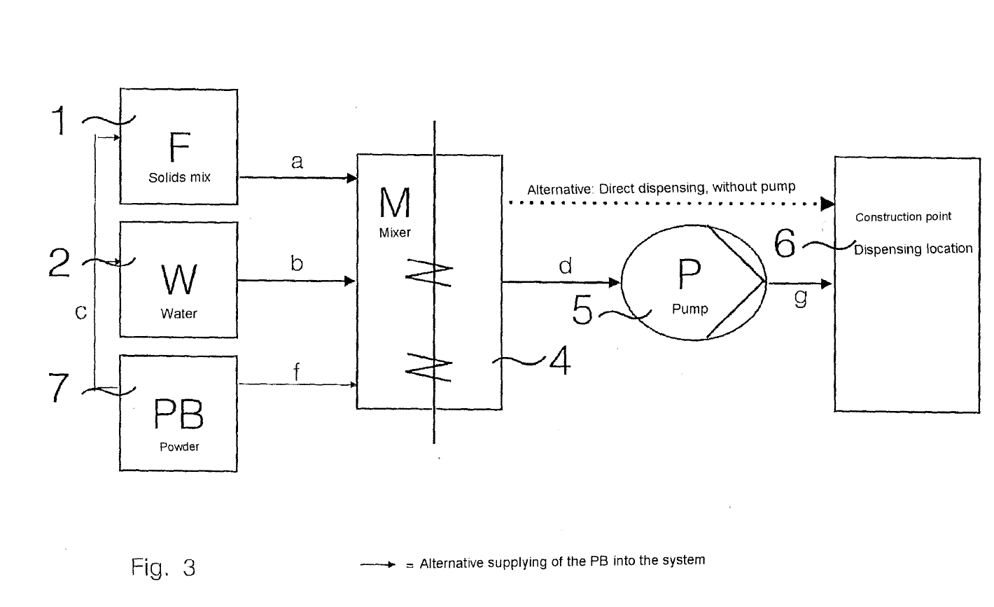

FIG. 3 shows an example of a method regime using a pulverulent, dry foaming agent. Again, a solids mix, i.e. binder and optionally aggregates, is charged to container 1. Mixing water is in container 2. Container 7 then contains the dry foaming agent, freeze-dried for example, which is added via line c to the binder in container 1 and/or to the mixing water in container 2. Via the flow of material, the pulverulent foaming agent is supplied to the mixer 4 or is added directly to the mixer 4 (here, diagrammatically, path f). In the mixer 4, a binder paste foam or a foamed building material slurry is produced, which, as already described for the preceding figures, is transported via lines d and g by means of pump 5 to the construction point 6 or into a mould.

Tests

To produce a gypsum paste, an alpha-hemihydrate (Südanit) or an anhydrite (Raddipur +) from Sudharzer Gipswerke and mains water are used. From a mixture according to formula example 2, a foam was produced using a two-pump foam generator (from Finke, Detmold).

In principle the foam can be added at any time before the gypsum paste stiffens, but the addition ought to take place as close as possible to the production of the paste. The paste must remain in the uncured state, in order to allow it to be mixed with the foam.

In principle, lightweight gypsum can be produced in a variety of densities. For these tests, the density classes selected were 450 kg/m³ and 850 kg/m³.

Tests: 1. Pumping

The paste or the slurry can be conveyed with any of the pumps presently available on the market; for foamed slurries, peristaltic pumps and screw pumps are suitable. The multiplicity of pump designs available and the variable points of foam addition require practical testing of the pump selected to determine whether it is able to achieve the desired outcome.

It is immaterial whether the pumps convey material produced in a batch process, or whether the material is produced continuously.

It is immaterial whether the lightweight gypsum is produced beforehand, in the pump, or immediately downstream of the pump in the conveying hose/pipe, or is produced in a low-maintenance or no-maintenance fluidizer/mixer element. It should be borne in mind, however, that piston pumps may destroy the pores of foamed slurries.

Tests: 2. Volume Stability

The porosified or foamed solids/water mixture (paste) can be pumped to more than 75 meters and withstands construction heights (liquid pouring) of more than 100 cm. At the same time, the material remains stable in volume, with no alteration in homogeneously distributed air pores. 99% of the air pores have a uniform size 2 mm. Larger pores occur only if, during dispensing, pumping or application, the movement of the paste allows air inclusions (overpouring, sloshing, etc.). These larger pores have no adverse effect on the overall pore structure if their proportion of the volume is below 2%.

Tests: 3. Aggregates/Content of Aggregates

Experiments have shown that any gypsum-based or cement-based paste can be porosified if the paste is not admixed with any chemistry which neutralizes the pore former or otherwise robs it of its capacity. The minimum binder content ought not to fall below 12.5% of the overall solids mass.

It should be borne in mind that for foamed building material slurries, the average compressive strengths and tensile strengths are generally lower than for unfoamed gypsum mixtures.

Reference Mixtures

The mixtures in the table below are subject to the following remarks. All of the mixtures use gypsum as example:

a—mixture No. 1 (reference mixture), without porosification

b—mixture No. 2, lightweight gypsum, density 850 kg/m³

c—mixture No. 3, lightweight gypsum, density 500 kg/m³ 40

TABLE 1

| | Per mixture | | | | | | Gypsum | Water |
|---|---|---|---|---|---|---|---|---|
| | Gypsum | Water | Foam | Density | Volume | Foaming agent example 1 | initial mass | initial mass |
| No. | KG | KG | Liters | (wetness per m³) | (liters per mixture) | (liters per mixture) | (KG per m³) | (KG per m³) |
| 1 | 55.9 | 29.6 | 0.0 | 1712.1 | 50.0 | 0 | 1119 | 593 |
| 2 | 28.0 | 14.8 | 25.5 | 848.0 | 50.5 | 0.04 | 554 | 294 |
| 3 | 16.5 | 8.7 | 35.8 | 499.5 | 50.5 | 0.05 | 326 | 173 |

Producing one cubic meter of lightweight gypsum requires the following quantities of gypsum (here alpha-hemihydrate):

| | |
|---|---|
| a - | 1119 kg gypsum |
| b - | 554 kg gypsum |
| c - | 326 kg gypsum |

Producing one cubic meter of lightweight gypsum requires the following quantities of water (here mains water):

| | |
|---|---|
| d - | 29.8 kg water |
| e - | 14.8 kg water |
| f - | 8.7 kg water |

From 50% to 125% of the indicated quantities of water can be used without detriment to the lightweight gypsum structure. Lower or higher quantities of water are possible, but are not advisable, owing to the occurrence of adverse contraction effects (more water than 125%) and possibly excessive toughness and excessively rapid curing for the desired operation (less than 50% water).

Producing one cubic meter of lightweight gypsum requires arithmetically the following quantities of pore formers (if a Finke foam generator is used):

| | |
|---|---|
| a - | 0.00 liter |
| b - | 0.75 liter |
| c - | 1.00 liter |

The reference mixtures can be carried out with all conceivable solids mixtures. In the calculation of foam volume and required quantities of pore formers, the different density of the solid should be taken into account.

II. Lightweight Gypsum Production by Supplying the Foaming Agent to the Mixing Water During Gypsum Paste Production

The gypsum paste is produced using an alpha-hemihydrate from Südharzer Gipswerke and mains water. The gypsum paste is prepared in a 150 1 mixer from EMT. A foam of undiluted foaming agent according to example foaming agent 1 is added to the mixing water.

Producing one cubic meter of lightweight gypsum requires arithmetically the following quantities of foaming agent:

| | |
|---|---|
| a - | 0.00 liter |
| b - | 0.20 liter |
| c - | 0.35 liter |

Comparative tests: when foaming agents without PCE were produced, in contrast, there was no operational reliability. The foams from the foaming agents collapsed within seconds to minutes, could not be pumped at sufficiently constant volume, and showed no volume stability even on curing.

1. A method for producing porous lightweight-construction and insulating materials, comprising the step of using a long-chain or medium-chain polycarboxylate ether (PCE) for stabilizing a foam from a foaming agent for building materials on the basis of ionic foaming surfactants.

2. The method according to claim 1, wherein the amount of the polycarboxylate ether (PCE) in the foaming agent before combining with a building material component is at least 0.1 wt %.

3. The method of claim 1, wherein the polycarboxylate ether (PCE) is used in combination with at least one glycol and at least one fatty alcohol.

4. A foaming agent for foaming of a building-material binder paste or a building material slurry for producing pory lightweight-construction and insulating materials, comprising:, a foam-forming ionic surfactant component;
at least one fatty alcohol; and
at least one polycarboxylate ether for stabilization in an aqueous-organic solvent, wherein the aqueous-organic solvent is selected from the group of alkyl glycols, alkylene glycols up to C6 alkyl, diglycols and diglycol ethers, and also,
optionally, up to a maximum of 20 wt % of the mixture, of further ingredients.

5. The foaming agent according to claim 4, comprising:
a) at least 2 wt % of said ionic, foam-forming surfactant,
b) at least 10 wt % of said aqueous-organic solvent,
c) at least 0.1 wt % of the at least one polycarboxylate ether (PCE),
d) at least 0.5 wt % of the at least one fatty alcohol,
e) at least 10 wt % of water, and
f) 0-20 wt % of other organic-chemical adjuvants and/or organic or inorganic acids or bases for pH adjustment, the mixture giving a total of 100 wt %.

6. The foaming agent according to claim 5, further comprising additional water up to 25 times a volume of the foaming agent.

7. The foaming agent according to claim 4, wherein the foaming agent is present in a pasty or pulverulent solid form obtainable by freeze drying or vacuum evaporation of the foaming agent.

8. A method for producing a pory lightweight-construction and insulating material by means of a binder paste foam or a foamed building material slurry, comprising the steps of foaming a foaming agent comprising
a foam-forming ionic surfactant component;
at least one fatty alcohol; and
at least one polycarboxylate ether for stabilization in an aqueous-organic solvent, wherein the aqueous-organic solvent is selected from the group of alkyl glycols, alkylene glycols up to C6 alkyl, diglycols and diglycol ethers, and also,
optionally, up to a maximum of 20 wt % of the mixture, of further ingredients, and
optionally with additional water,
to produce a resulting foam; and
combining the resulting foam with mixing water for a binder, with a binder paste composed of binder and mixing water and also, optionally, additives, or with a building material slurry composed of the binder paste and aggregates, to produce the binder paste foam or the foamed building material slurry.

9. The method according to claim 8, wherein the resulting foam from the foaming agent is supplied, within a binder paste preparation method,
to at least one starting material in a container or to a transfer line,
to a mixer or foam generator,
to a pump, or
to a fresh building material delivery line.

10. The method of claim 8 wherein the foaming agent is added to dry binder or to mixing water, and wherein the binder paste foam is generated on mixing of the binder with the mixing water.

11. The method according to claim 8 wherein the binder includes one or more of cement, gypsum, and lime, alone or in any desired mixture with one another or with other mineral constituents.

12. The method according claim 8 further comprising the step of either transporting the binder paste foam or the foamed building material slurry, prior to setting and curing, to a construction point, or pouring the binder paste foam or the foamed building material slurry into a mold and curing the binder past foam or the foamed building material slurry in the mold.

13. The method according to claim 12, wherein the step of curing in the mold takes place in an integrated system with other materials.

14. The method according to claim 12, wherein the step of curing takes place under pressure and at elevated temperature in an autoclave.

15. The method according to claim 8, further comprising the steps of
forming a formed or freely poured lightweight-construction and insulating material from the the binder paste foam or the foamed building material slurry; and
performing one or more of cutting, sawing, or milling of the formed or freely poured lightweight-construction and insulating material to produce porous lightweight construction products.

16. Porous lightweight construction products, made by the process of:
producing a pory lightweight-construction and insulating material by means of a binder paste foam or a foamed building material slurry, comprising the steps of foaming a foaming agent comprising
a foam-forming ionic surfactant component;
at least one fatty alcohol; and
at least one polycarboxylate ether for stabilization in an aqueous-organic solvent, wherein the aqueous-organic solvent is selected from the group of alkyl glycols, alkylene glycols up to C6 alkyl, diglycols and diglycol ethers, and also,
optionally, up to a maximum of 20 wt % of the mixture, of further ingredients, and
optionally with additional water,
to produce a resulting foam; and
combining the resulting foam with mixing water for a binder, with a binder paste composed of binder and mixing water and also, optionally, additives, or with a building material slurry composed of the binder paste and aggregates, to produce the binder paste foam or the foamed building material slurry;
forming a formed or freely poured lightweight-construction and insulating material from the the binder paste foam or the foamed building material slurry; and
performing one or more of cutting, sawing, or milling of the formed or freely poured lightweight-construction and insulating material to produce porous lightweight construction products.
